(19) United States
(12) Patent Application Publication
(10) Pub. No.: US 2008/0112395 A1
(43) Pub. Date: May 15, 2008

(54) METHOD FOR VOICE SERVICE BASED ON SERVICE TRIGGER, AND METHOD AND SYSTEM FOR ROUTING CONTROL OF VOICE SERVICE BASED ON SERVICE TRIGGER

(75) Inventors: Dongming Zhu, Shenzhen (CN); Hai Zhang, Shenzhen (CN); Xiaoqin Duan, Shenzhen (CN); Peng Zhang, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/952,273

(22) Filed: Dec. 7, 2007

Related U.S. Application Data
(63) Continuation of application No. PCT/CN2006/001238, filed on Jun. 7, 2006.

(30) Foreign Application Priority Data
Jun. 7, 2005 (CN) 200510075022.5
Jun. 16, 2005 (CN) 200510075378.9

(51) Int. Cl. H04L 12/66; H04Q 7/20

(52) U.S. Cl. 370/352; 455/445

(57) ABSTRACT

A method for providing a voice service based on service trigger includes: a Routing Policy Decision Points (RPDP) with a Domain Selection Function (DSF) acquiring a delivery attempt state of a call or session, wherein the DSF is capable of selecting a domain; the RPDP with the DSF controlling the call or session in response to the delivery attempt state of the call or session. An apparatus for providing a voice service based on service trigger and a method and an apparatus for routing control of a voice service based on service trigger are also disclosed. In this way, when a failure occurs on the call or session that has been routed to the called side, the RPDPs are able to control the follow-up call or session process in response to the control process logic of the RPDPs.

This application is a continuation of International Patent Application No. PCT/CN2006/001238, filed Jun. 7, 2006, which claims priority to Chinese Patent Application No. 200510075022.5, filed Jun. 7, 2005, and Chinese Patent Application No. 200510075378.9, filed Jun. 16, 2005, all of which are hereby incorporated by reference.

### FIELD OF THE INVENTION

The present invention relates to the voice service technology, and particularly, to a method and a system for routing control of a voice service based on service trigger and a method for providing a voice service based on service trigger.

### BACKGROUND OF THE INVENTION

Since the Release 5 of the 3^{rd} Generation Partnership Project (3GPP R5), the core network of the Universal Mobile Telecommunications System (UMTS) has been divided into three sub-systems: a Circuit Switched (CS) domain, a Packet Switched (PS) domain and an IP Multimedia Subsystem (IMS) domain.

The CS domain is used for providing circuit based service connections for subscribers. The CS domain includes: a Mobile Switch Center or a CS-Media Gateway (MSC or CS-MGW), a Gateway MSC (GMSC) and an InterWorking Function (IWF). The MSC is used for the switching and signal control of a circuit switched service; the GMSC is a type of MSC for routing a mobile user in a network and may be configured in a same entity with the MSC or may be configured as an entity separate from the MSC; and the IWF is closely associated with the MSC and used for signaling conversion between the Public Land Mobile Network (PLMN) and the Integrated Service Digital Network (ISDN), or between the Public Land Mobile Network (PLMN) and the Public Switched Telephone Network (PSTN), or between the Public Land Mobile Network (PLMN) and the Packet Data Network (PDN) in order to achieve interworking between networks, the functions of the IWF are closely related to the types of services and networks.

The PS domain is used for providing packet based service connections for subscribers. The PS domain includes: a GPRS Supporting Node (GSN), a Border Gateway (BG), a Home Location Register or an Authentication Center (HLR or AuC), a Visitor Location Register (VLR), an Equipment Identity Register (EIR) and an MSC. The GSN is used for transmitting packets for a packet service subscriber and includes a Service GPRS Supporting Node (SGSN) and a Gateway GPRS Supporting Node (GGSN). The SGSN provides a connection between a core network and a Base Station Subsystem (BSS) or a Radio Network Subsystem (RNS) of a radio access system, and is used for performing mobility management and session management for a packet data service to manage the mobility and communication services of a Mobile Station (MS) in a mobile network. The GGSN functions as interfaces between a mobile communication system and other public data networks and provides the function of location information interrogation. Both the SGSN and the GGSN may provide charging information. The BG is used for interworking between two GPRS networks and ensuring the interworking security. The HLR is used for managing user subscription data and location information. The user subscription data includes a Mobile Station International ISDN Number (MSISDN), an International Mobile Subscriber Identity (IMSI), a Packet Data Protocol (PDP) ADDRESS, subscribed telecommunication services and supplementary services, and the application scope of the services, and the location information includes a Mobile Station Roaming Number (MSRN), a MSC or a VLR number, an SGSN number, a Gateway Mobile Location Center (GMLC), etc. The AuC is used for storing authentication algorithms and secret keys of subscribers. The VLR is used for processing data information of visitors. The EIR is used for storing the International Mobile station Equipment Identity (IMEI) of user equipment.

The IMS is a subsystem superimposed on the existing PS domain in the Wideband Code Division Multiple Access (WCDMA) network in the 3GPP R5. In the IMS the PS domain serves as a carrier channel for the upper layer IMS control signaling and media transmission. Session Initial Protocol (SIP) is also introduced into the IMS as the service control protocol. Because the SIP is simple, easy to extend, and convenient in media combination, service control and carrier control may be separated, and thus rich varieties of multimedia services may be provided. Function entities in the IMS include: a Call Session Control Function (CSCF) entity for managing subscriber registration and session control, an Application Server (AS) for providing various service logic control functions, a Home Subscriber Server (HSS) for managing user subscription data in a centralized mode and a Multimedia Gateway Control Function or an IMS Multimedia Gateway (MGCF or IM-MGW) for communicating with a circuit switching network. A subscriber may connect to the IMS via a Proxy Call Session Control Function (P-CSCF) of the present location of the subscriber, and the session, service triggering control and the service control interaction with the AS is implemented by a home Serving CSCF (S-CSCF) of the subscriber.

The HSS in the IMS is a superset of the HLR and is compatible with the functions of the HLR. However, mostly the HSS and the CS or the PS HLR are installed separately in practical applications because of factors such as the networking procedure and so on.

The IMS architecture defined by 3GPP solves all crucial operability problems of multimedia services over IP, such as roaming charging, Quality of Service (QoS) and security. Therefore the IMS architecture and corresponding theory have been recognized by the industry. Both 3GPP2 and Telecom & Internet converged Service & Protocols for Advanced Network (TISPAN) define corresponding IP multimedia network architecture and service system based on and with reference to the 3GPP model while 3GPP has started researching on the interworking between the WLAN and the UMTS, e.g., Interworking of WLAN (I-WLAN), on the Fixed Broadband access to IMS (FBI) and on the multiple access technologies oriented All-IP Network (AIPN). A future subscriber will be able to connect to the IMS according to his or her subscription through different access networks with a single multi-mode terminal or different terminals of various types, so that the future subscriber may enjoy unified multimedia services including Voice over IP (VoIP).

An IMS architecture based service platform also provides IP based voice services, e.g., VoIP services, and an operator may apply different charging rates to a CS domain based voice service and an IMS domain based voice service, so a to-be-established call or session needs to be routed in the CS domain or in the IMS domain flexibly according to routing policies of the operator and preference settings of the user. Furthermore, the operator may provide CS domain based voice services or IMS domain based voice services in different areas. Hence the continuity of an established call or session needs to be maintained when the user roams and corresponding voice service is switched between the CS domain and the IMS domain, so that seamless switching of voice services between the CS domain and the IMS domain has to be guaranteed.

The 3GPP has just launched a research project on the service continuity between a CS call and a VoIP service provided by the IMS through an IP-Connectivity Access Network (IP-CAN), and the research project focuses on the routing control and switching. The 3GPP puts forwards two solutions for routing selection of a subscriber: routing based on service trigger and routing based on enhanced HLR or HSS.

In a routing control scheme based on a service trigger, when the call is from the CS domain, the Routing Policy Decision Point (RPDP) is the gsm Service Control Function (gsmSCF) in the CS domain; and when the session is from the IMS domain, the RPDP is the AS in the IMS domain. The CS domain and the IMS domain may belong to a same operator or to different operators. Therefore it has to be guaranteed that synchronized and associated routing policy decision data are kept on different RPDPs to keep the routing process continuity of the voice service between the CS domain and the IMS domain. For example, if an operator wishes to bar the voice service for a subscriber who has gone overdrawn, the operator may set up Operator Determined Barring (ODB) data in the CS domain for the subscriber and the gsmSCF will accordingly bar the voice service for the subscriber according to the ODB data while making the routing policy decision. Similarly, the AS functioning as the RPDP in the IMS domain is also configured to bar the voice services for the subscriber while making the routing policy decision. For another example, if the gsmSCF functioning as the RPDP routes a call to the IMS domain according to the routing policy of the CS domain, the AS functioning as the RPDP in the IMS domain should prevent the session from being routed back to the CS domain according to the routing policy of the IMS domain.

In the conventional routing control method of voice service, no consideration is given to the synchronization and association of the routing policy decision related data on two different RPDPs, i.e., the gsmSCF and the AS. Therefore it is difficult to maintain routing control consistency of voice services between the CS domain and the IMS domain and the call or the session may enter into an unlimited routing cycle between the two domains, which reduces the success ratio of the voice services.

### SUMMARY OF THE INVENTION

The present invention provide a method for voice service routing control based on service trigger, which assures the routing control consistency of voice services between different domains and improves the success ratio of the voice services.

The present invention also provides an apparatus for routing control of a voice service based on service trigger, which assures the routing control consistency of voice services between different domains and improves the success ratio of the voice services.

The present invention also provide a method and an apparatus for providing a voice service based on service trigger, which include the follow-up the call or the session control for a voice service that has already been routed to the called side, so as to improve the call or the session control mechanism in the voice service and improve the success ratio of the call or the session in the voice service.

A method for routing control of a voice service based on service trigger includes:

acquiring, by a Routing Policy Decision Point (RPDP) with a Domain Selection Function (DSF), routing policies of a subscriber of a voice service in different network domains, wherein the DSF is capable of selecting domains; and

controlling, by the RPDP with the DSF, routing of the voice service in response to the routing policies of the subscriber in different network domains.

An apparatus for routing control of a voice service based on service trigger, has Domain Selection Function (DSF) capable of selecting a domain, and includes:

a first module, configured to acquire routing policies of a subscriber of a voice service in different network domains; and

a second module, configured to control the routing of the voice service in response to the routing policies received from the first module.

A method for providing a voice service based on service trigger includes:

acquiring, by a Routing Policy Decision Point (RPDP) with a Domain Selection Function (DSF), a delivery attempt state of a call or a session, wherein the DSF is capable of selecting a domain; and

controlling, by the RPDP with the DSF, the call or the session in response to the delivery attempt state of the call or the session.

An apparatus for providing a voice service based on service trigger, has Domain Selection Function (DSF) capable of selecting a domain, and includes:

a first module, configured to acquire a delivery attempt state of a call or a session; and

a second module, configured to control the call or the session in response to the delivery attempt state of the call or the session.

It can be seen from the above technical scheme that the present invention has the following advantages and features.

According to the routing control method of the present invention, the routing policies of the subscriber in two different domains may be taken as the reference when a routing decision is made, and thus, the RPDPs in the two different domains will always apply the same routing control policy for the subscriber in different calls or sessions.

The solutions provided by the present invention protect the voice service from roundabout route or even cycling route incurred by unsynchronized routing policy information, so as to guarantee the routing control consistency of the voice service in different domains and improve the success ratio of the voice service.

The RPDPs in the present invention are able to acquire a delivery attempt state of a call or session in the whole call or session process of the voice service to control the call or session in the whole call or session process of the voice service. Therefore, when a failure occurs on the call or session that has been routed to the called side, the RPDPs are able to control the follow-up call or session process according to the control process logic of the RPDPs.

### BRIEF DESCRIPTION OF THE DRAWINGS

FIG. 1 is a schematic diagram illustrating a conventional method for routing control of a voice service based on service trigger.

FIG. 2 is a flow chart illustrating a conventional method for providing a voice service based on a CAMEL triggered process.

FIG. 3 is a flow chart illustrating a conventional method for providing a voice service based on an AS controlled process.

FIG. 4 is a schematic diagram illustrating a method for routing control of a voice service based on service trigger according to a first embodiment of the present invention.

FIG. 5 is a schematic diagram illustrating IM-SSF interfaces and a conventional method for providing a service in an IMS domain.

FIG. 6 is a flow chart illustrating a method for routing control of a voice service based on service trigger according to a first embodiment of the present invention.

FIG. 7 is a schematic diagram illustrating a method for routing control of a voice service based on service trigger according to a second embodiment of the present invention.

FIG. 8 is a schematic diagram illustrating a method for routing control of a voice service based on service trigger according to a third embodiment of the present invention.

FIG. 9 is a schematic diagram illustrating a method for routing control of a voice service based on service trigger according to a fourth embodiment of the present invention.

FIG. 10 is a schematic diagram illustrating another method for routing control of a voice service based on service trigger according to the fourth embodiment of the present invention.

FIG. 11 is a flow chart illustrating a method for providing a voice service based on a CAMEL triggered process in accordance with an embodiment of the present invention.

FIG. 12 is a flow chart illustrating a method for providing a voice service based on an AS controlled process in accordance with an embodiment of the present invention.

### DETAILED DESCRIPTION OF THE INVENTION

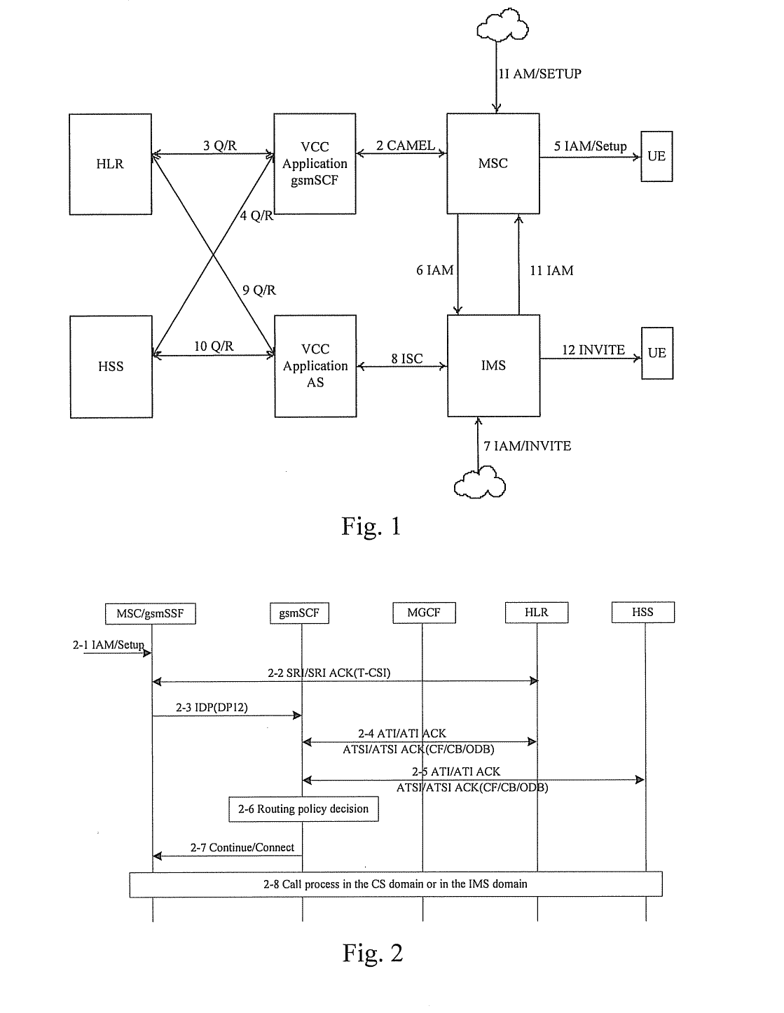

The technical scheme of the routing based on service trigger is shown in FIG. 1. In FIG. 1, a service in the CS domain is triggered based on the Customized Applications for Mobile Network Enhanced Logic (CAMEL) and a service in the IMS domain is triggered based on the AS control. Upon the receipt of a call from the CS domain, the MSC triggers the terminating CAMEL service according to the user subscription data and sets up a service control relation with a gsm Service Controlling Function (gsmSCF) which functions as a Routing Policy Decision Point (RPDP). Upon the receipt of a call from the IMS domain, the S-CSCF triggers the service control according to the user subscription data and sets up a service control relation with the AS which functions as a Routing Policy Decision Point (RPDP). The gsmSCF and the AS store routing policies, make routing policy decision according to the routing policy decision related information obtained from the GMSC or S-CSCF and from the HLR or HSS, and perform routing control via the service control relation set up with the GMSC or S-CSCF.

The routing control based on service trigger for a call from the CS domain includes the following processes.

When receiving a call from the CS domain and triggering the terminating CAMEL service according to the user subscription data, the MSC sets up a service control relation with the gsmSCF which functions as the RPDP. The gsmSCF interrogates the HLR or the HSS for the state information of a called subscriber, makes the routing policy decision according to the state information of the called subscriber together with the routing policies of the operator and the preference settings of the subscriber, and performs the follow-up routing control. For example, when determining that the subscriber needs the call to be routed in the CS domain, the gsmSCF sends a CONTINUE operation to the MSC having gsm Service Switching Function (gsmSSF) so that the MSC may route the call to the called subscriber in the CS domain after acquiring the roaming number of the called subscriber from the HLR according to the called number. For another example, when determining that the subscriber needs the call to be switched to the IMS domain for routing, the gsmSCF sends the MSC having the gsmSSF a CONNECT operation carrying a number pointing to the MGCF, the MSC having the gsmSSF may route the call to the MGCF according to the number pointing to the MGCF, and then the MGCF may take over the call routing process in the IMS domain, in this way the call initiated in the CS domain is switched to the IMS domain and further routed to the called subscriber.

FIG. 2 shows a process in which a call from the CS domain is routed in the CS domain or to the IMS domain after the gsmSCF makes a routing policy decision for the call, the process includes the following steps.

2-1: The MSC having the gsmSSF receives an incoming call signaling, i.e., an Initial Address Message (IAM), or a call setup signaling initiated by a caller terminal.

2-2: The MSC having the gsmSSF sends Send Routing Information (SRI) to the HLR according to the called number and the HLR returns the Terminating-CAMEL Subscription Information (T-CSI) of the called subscriber to the MSC having the gsmSSF.

2-3: The MSC having the gsmSSF sends an Initial Detected Point (IDP) to corresponding SCP according to the returned T-CSI in order to trigger an intelligent service.

2-4: The gsmSCF, optionally, interacts with the HLR according to the service logic defined by the service key of the CSI triggered by the gsmSSF to interrogate for the routing policy decision related information, e.g., the gsmSCF sends an Any Time Interrogation or Any Time Subscription Interrogation (ATI or ATSI) to the HLR to interrogate for the registration information and corresponding service subscription information of the called subscriber in the CS domain.

2-5: The gsmSCF, optionally, interacts with the HSS according to the service logic defined by the service key of the CSI triggered by the gsmSSF to interrogate for the routing policy decision related information, e.g., the gsmSCF sends an ATI or an ATSI to the HSS to interrogate for the registration information and corresponding service subscription information of the called subscriber in the IMS domain.

In practical applications, 2-4 and 2-5 may also be performed in a reserved order.

2-6: The gsmSCF determines the routing policy for the call according to the acquired routing policy decision related information, e.g., the registration information of the called subscriber in the CS domain and in the IMS domain, corresponding service subscription information and the routing policy information stored in the gsmSCF.

2-7: The gsmSCF sends a CONTINUE operation to the MSC having the gsmSSF according to the determined routing policy, indicating that the call shall be routed in the CS domain, or the gsmSCF sends a CONNECT operation to the MSC having the gsmSSF, indicating that the call shall be routed in the IMS domain.

2-8: The MSC having the gsmSSF routes the call in the CS domain or in the IMS domain according to the operations sent by the gsmSCF.

The routing control based on service trigger for a session from the IMS domain includes the following processes.

Upon the receipt of the session from the IMS domain, the S-CSCF in the IMS domain sends the session to an AS according to the initial Filter Criteria (iFC), and the AS functioning as an RPDP determines the routing policy for a called subscriber according to the state information of the called subscriber acquired from the HLR or the HSS together with the routing policies of the operator and the preference settings of the subscriber, and performs follow-up routing control. For example, if the AS determines that the called subscriber needs the session to be routed in the IMS domain, the INVITE message sent by the AS to the S-CSCF will carry original called information, in this way, the S-CSCF may continue with the session control to route the session in the IMS domain further to the called subscriber according the original called information. For another example, if the AS determines that the called subscriber needs the session to be switched to the CS domain for further routing, the INVITE message sent by the AS to the S-CSCF will carry an E.164 number pointing to the MGCF, in this way, the S-CSCF may route the session to the MGCF through the Breakout Gateway Control Function (BGCF) according to the E.164 number pointing to the MGCF, and then the MGCF further routes the session to the CS domain. Thus, the routing control on the session initiated in the IMS domain and routed to the called subscriber in the CS domain is achieved.

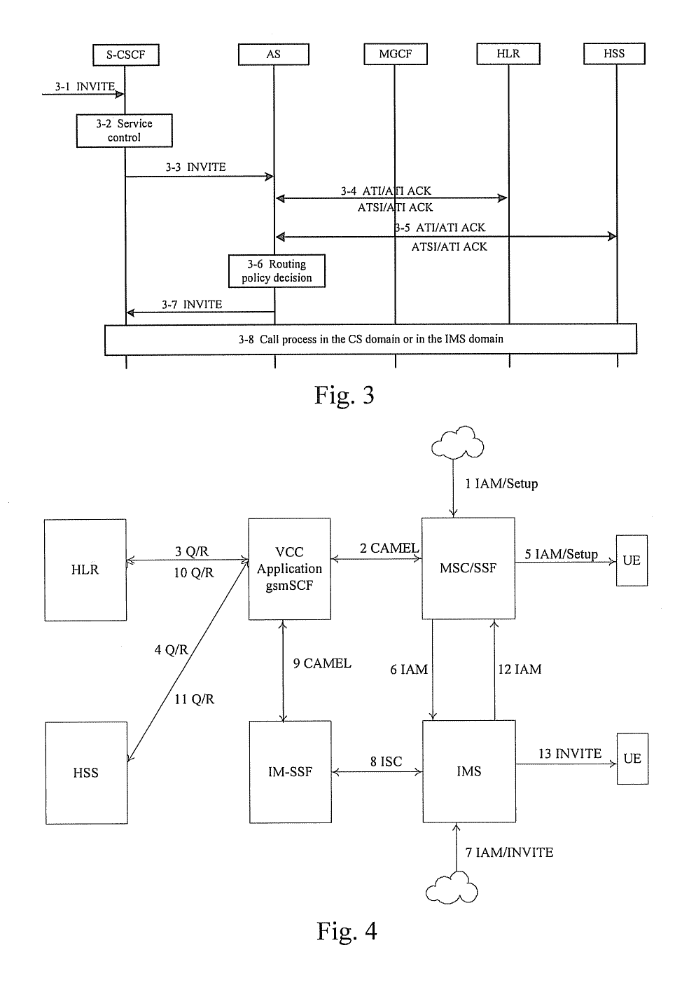

FIG. 3 shows a process in which a session from the IMS domain is routed to the CS domain or routed in the IMS domain after the AS makes a routing policy decision for the session, the process includes the following steps.

3-1: The S-CSCF receives a session signaling, i.e., an INVITE message.

3-2 and 3-3: The S-CSCF triggers service logic for the session according to the filter information in the iFC and forwards the INVITE message to the AS.

3-4: The AS, optionally, interacts with the HLR according to the defined service logic to interrogate for the routing policy decision related information, e.g., the AS sends an ATI or an ATSI to the HLR to interrogate for the registration information and corresponding service subscription information of the called subscriber in the CS domain.

3-5: The AS, optionally, interacts with the HSS according to the defined service logic to interrogate for the routing policy decision related information, e.g., the AS sends an ATI or an ATSI to the HSS to interrogate for the registration information and corresponding service subscription information of the called subscriber in the IMS domain.

In practical applications, the 3-4 and 3-5 may also be performed in a reserved order.

3-6: The AS determines a routing policy for the session according to the acquired routing decision related information, e.g., the registration information of the called subscriber in the CS domain and in the IMS domain, corresponding service subscription information and the routing policy information stored in the AS.

3-7: The AS sends an INVITE message to the S-CSCF according to the determined routing policy. If the session needs to be routed in the IMS domain, the INVITE message will still carry original address information of the called subscriber, i.e., an original Request-Uniform Resource Identifier (Request-URI), so that the S-CSCF may route the session to the P-CSCF of the called subscriber according to the original Request-URI and the session is further routed in the IMS domain to the called subscriber. If the session needs to be routed to the CS domain, the INVITE message will carry the modified address information of the called subscriber, e.g., an E.164 number pointing to the MGCF, so that the C-CSCF may route the session to the MGCF through the BGCF according to the E.164 number pointing to the MGCF, and the MGCF further routes the session to the CS domain.

3-8: The S-CSCF routes the session according to the INVITE message from the AS so that the session may be processed in the CS domain or in the IMS domain.

The present invention includes that: a Routing Policy Decision Point (RPDP) with a Domain Selection Function (DSF) acquires routing policies of a subscriber of a voice service in different network domains, and the RPDP controls the routing of the voice service according to the routing policies of the subscriber in different network domains. The DSF is capable of selecting a domain. The domain indicates different network domains, e.g., a CS domain or an IMS domain.

The method and system provided by the present invention for routing control of a voice service based on service trigger are further described hereafter.

The voice service in the present invention is a voice service based on service trigger across different domains. When the different domains are a CS domain and an IMS domain, the voice service based on service trigger includes: a call initiated in the CS domain, which needs to be routed to the IMS domain and the routing control of which shall be performed by the CAMEL, or a session initiated in the IMS domain, which needs to be routed to the CS domain and the routing control of which shall be performed by an AS or the CAMEL. When a voice service is routed between a 2G CS domain and a 3G CS domain, the voice service based on service trigger in the present invention includes: a call initiated in the 2G CS domain, wherein the call needs to be routed to the 3G CS domain and the called oriented routing control of the call shall be performed by the CAMEL; or a call initiated in the 3G CS domain, wherein the call needs to be routed to the 2G CS domain and the called oriented routing control of the call shall be performed by the CAMEL. When the voice service is routed between at least two IMS domains based on different access types, e.g., an IMS domain based on WLAN access and an IMS domain based on GPRS access, the voice service based on service trigger in the present invention includes: a session initiated in an IMS domain based on one access type, wherein the session needs to be routed to an IMS domain based on another access type and the called oriented routing control of the session shall be performed by the AS.

The technical scheme of the present invention is further described with reference to an embodiment of the method for voice service routing control between a CS domain and an IMS domain.

A method for routing control of a voice service based on service trigger according to a first embodiment of the present invention is shown in FIG. 4. In FIG. 4, the RPDP of the CS domain and the RPDP of the IMS domain are one same entity, i.e., the AS which functions as the RPDP of the IMS domain is installed in an entity where the gsmSCF of the CS domain is located. Therefore the entity where the gsmSCF of the CS domain is located will store both the routing policy of the subscriber in the CS domain and the routing policy of the subscriber in the IMS domain.

An entity having the functions of the CAMEL should be added into the IMS domain when the AS which functions as the RPDP of the IMS domain is installed in the entity where the gsmSCF of the CS domain is located, i.e., an IP Multimedia-Service Switching Function (IM-SSF) node should be added into the IMS domain.

The IM-SSF functions as an AS in the IMS domain. The IMS provides subscribers in the IMS domain with value-added IM services through varieties of ASs. The ASs includes: a SIP AS, an OSA AS and an IM-SSF. The IM-SSF is used for mapping the IMS SIP onto the CAMEL Application Part (CAP) of the CS domain and providing triggering capability of the Service Switching Point (SSP) so that VoIP service subscribers in the IMS domain may seamlessly access intelligent services of the CS domain.

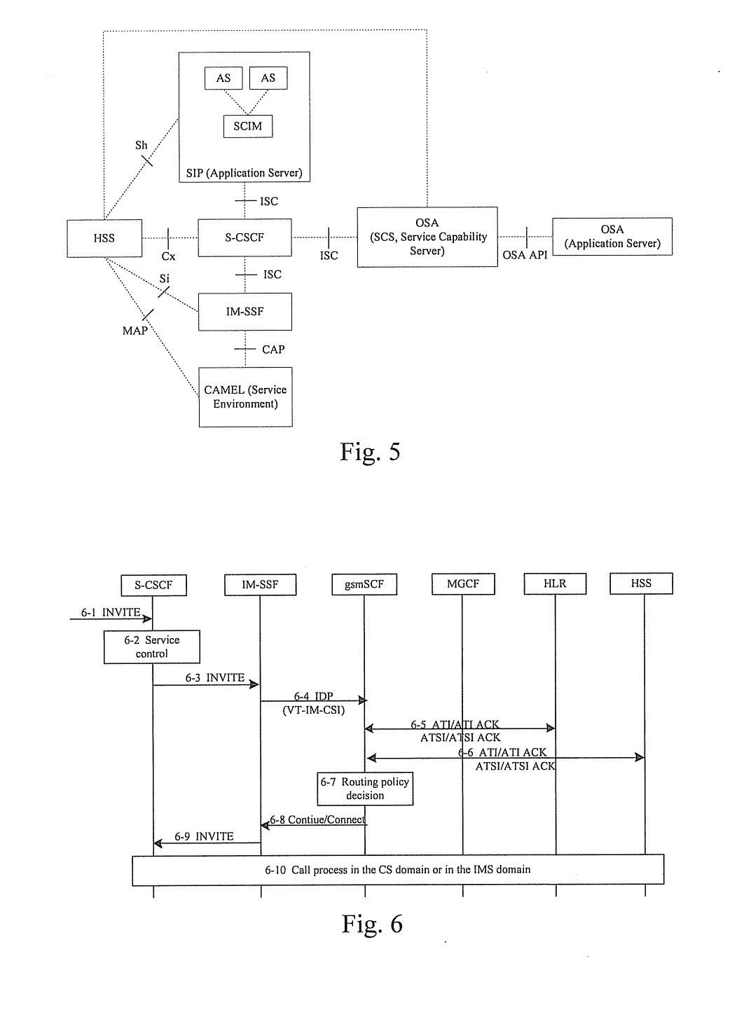

The method for providing a service in the IMS domain and IM-SSF interfaces are as shown in FIG. 5. In FIG. 5, the IM-SSF supports three interfaces. Specifically, a CAP interface to the CAMEL service environment, e.g., the gsmSCF; an ISC interface to the S-CSCF, wherein the ISC interface enables the gsmSCF to control an IP multimedia session passing through the S-CSCF via the IM-SSF according to the intelligent service logic of the gsmSCF; and a MAP based Si interface between the IM-SSF and the HSS for downloading CAMEL subscription information of the subscriber from the HSS and updating the CAMEL subscription information.

The IM-SSF triggers an intelligent service on the gsmSCF with the CAMEL subscription information (CSI). The CSI includes: Origination-IP Multimedia-CSI (O-IM-CSI) for the session originating side, Dial-in-IP Multimedia-CSI (D-IM-CSI) for a dial service and Visited Termination-IP Multimedia-CSI (VT-IM-CSI) for the session terminator side. The session routing control mechanism of the gsmSCF is similar to the call routing control mechanism of the gsmSCF in the CS domain. For example, when deciding that the called subscriber needs the session to be routed in the IMS domain, the gsmSCF sends a CONTINUE operation to the IM-SSF, and the IM-SSF sends an INVITE message carrying the original information of the called subscriber to the S-CSCF, so that the S-CSCF continues with the session control in the IMS domain according to the original information of the called subscriber until the session is routed to the called subscriber. For another example, when deciding that the called subscriber needs the session to be routed to the CS domain, the gsmSCF sends a CONNECT operation which carries an E.164 number pointing to the MGCF to the IM-SSF, the IM-SSF in turn sends an INVITE message to the S-CSCF and the INVITE message carries the E.164 number pointing to the MGCF in the CONNECT operation. Therefore the S-CSCF routes the session to the MGCF via the BGCF according to the E.164 pointing to the MGCF, and then the MGCF routes the session to the CS domain, and thus the routing control of the session which is initiated in the IMS domain and routed to the CS domain and further to the called subscriber is completed.

In FIG. 4, when receiving a call initiated in the CS domain, the gsmSCF of the CS domain decides the called subscriber of the call, interrogates the HLR or the HSS for the routing policy decision related information of the called subscriber, e.g., the registration information and service subscription information of the called subscriber, and acquires the routed path information of the call from the gsmSCF of the CS domain, and then makes a routing policy decision for the called subscriber according to the routing policies of the subscriber in the CS and the IMS domains, which are stored in the entity where the gsmSCF is located, such as the routing policies of the operator and the preference settings of the subscriber, and according to the routing policy decision related information returned from the HLR or HSS and the routed path information of the call; after that the gsmSCF controls the routing of the call according to the decided routing policy. For example, when the gsmSCF determines that the call needs to be routed to the IMS domain according to the routing policies of the subscriber in the CS and the IMS domains and the routing policy decision related information, and the routed path information of the call shows that the call is not routed from the IMS domain, then the call will be routed to the IMS domain. For another example, when the gsmSCF determines that the call needs to be routed to the IMS domain according to the routing policies of the subscriber in the CS and the IMS domains and the routing policy decision related information, yet the routed path information of the call shows that the call is routed from the IMS domain, then the routing policy for the call will be modified and the call will be routed in the CS domain under the routing control. Upon deciding the final routing policy for the call, the gsmSCF should store the routing policy for the call for further reference of the gsmSCF.

When receiving a session initiated in the IMS domain, the S-CSCF of the IMS domain triggers the session on an AS according to the iFC, i.e., triggers the session on the IM-SSF. The IM-SSF triggers the CAMEL service on the gsmSCF of the CS domain according to the VT-IM-CSI information of the called subscriber so that the gsmSCF of the CS domain interrogates, according to the called subscriber ID in the call, the HLR or HSS for the routing policy decision related information of the called subscriber, e.g., the registration information and corresponding service subscription information of the called subscriber, and acquires the routed path information of the call from the gsmSCF of the CS domain, then the gsmSCF of the CS domain makes a routing policy decision for the session according to the routing policy decision related information returned from the HLR or the HSS and the routing policies of the subscriber in the CS and the IMS domains, which are stored in the entity where the gsmSCF is located, such as the routing policies of the operator and the preference settings of the subscriber, and also according to the routed path information; after that the gsmSCF controls the routing of the session according to the decided routing policy. Upon deciding the final routing policy for the session, the gsmSCF should store the routing policy for the session for further reference of the gsmSCF. The use of the routed path information has already been given above and will not be described herein again.

In the method of the first embodiment shown in FIG. 4, the gsmSCF which functions as the RPDP of the CS domain and the AS which functions as the RPDP of the IMS domain are installed in a same entity, i.e., the CS domain and the IMS domain have only one RPDP altogether. Therefore the two domains may share a same set of routing policies to ensure the sharing of dynamic data generated in the routing control process of the voice service across the two domains, e.g., the sharing of a virtual roaming number assigned for compulsory routing, and to ensure the integrity of the routing control process. The method also prevents roundabout routing incurred by unsynchronized routing policy information and enables operators to process and maintain the routing policy information in a more convenient way.

FIG. 6 shows a detailed workflow of the method of the first embodiment, with which a session from the IMS domain is routed in the IMS domain or to the CS domain according to the routing policy decision made by the gsmSCF of the CS domain. The workflow includes the following steps.

6-1: The S-CSCF receives a session signaling, i.e., an INVITE message.

6-2 to 6-3: The S-CSCF triggers service for the session according to filter information in the iFC and forwards the INVITE message to the AS, which has the function of IMS-SSF.

6-4: The IMS-SSF sends an IDP to the gsmSCF according to the VT-IM-CSI of the called subscriber to trigger an intelligent service.

6-5: The gsmSCF, optionally, interacts with the HLR according to the service logic defined by the service key of the VT-IM-CSI triggered by the IM-SSF, in order to interrogate for the routing policy decision related information, e.g., the gsmSCF optionally sends an ATI or an ATSI to the HLR to interrogate for the registration information and corresponding service subscription information of the called subscriber in the CS domain.

6-6: The gsmSCF, optionally, interacts with the HSS according to the service logic defined by the service key of the VT-IM-CSI triggered by the IM-SSF, in order to interrogate for the routing policy decision related information, e.g., the gsmSCF optionally sends an ATI or an ATSI to the HSS to interrogate for the registration information and corresponding service subscription information of the called subscriber in the IMS domain.

In practical applications, 6-5 and 6-6 may also be performed in a reserved order.

6-7: The gsmSCF makes a routing policy decision for the session according to the acquired registration information and corresponding service subscription information of the called subscriber in the CS and the IMS domains and according to the routing policies stored in the gsmSCF.

6-8: The gsmSCF sends a CONTINUE operation to the IM-SSF according to the routing policy decision to indicate that the session is routed in the IMS domain, or the gsmSCF sends a CONNECT operation which carries an E.164 number pointing to the MGCF to the IM-SSF to indicate that the session is routed to the CS domain.

6-9: The IM-SSF sends an INVITE message to the S-CSCF according to the received routing policy decision. If the session needs to be routed in the IMS domain, the INVITE message still carries original address information of the called subscriber, i.e., an original Request-URI, so that the S-CSCF may route the session to the P-CSCF of the called subscriber according to the original Request-URI and the session will be further routed in the IMS domain to the called subscriber. If the session needs to be routed in the CS domain, the INVITE message carries the modified address information of the called subscriber, e.g., an E.164 number pointing to the MGCF, so that the C-CSCF may route the session to the MGCF through the BGCF according to the E.164 number pointing to the MGCF, and the MGCF further routes the session to the CS domain.

6-10: The S-CSCF routes the session according to the INVITE message from the IM-SSF and after that, the session will be processed in the CS or in the IMS domain.

In 6-7, in order to prevent roundabout routing or cycling routing of the voice service, while deciding that the session needs to be routed to the CS domain according to the registration information and corresponding service subscription information of the called subscriber in the CS and IMS domains and according to the routing policies stored in the gsmSSF, the gsmSCF may further determine whether this routing control process has been performed for the session, i.e., the gsmSCF acquires the routed path information of the voice service from the gsmSCF. If the routed path information of the voice service shows that the session is routed from the CS domain to the IMS domain, the gsmSCF should not route the session back to the CS domain, in such case the gsmSCF may choose another routing control method for the session, e.g., modify the routing policy decision so that the session will still be routed in the IMS domain.

The routing control process performed by the gsmSCF of the CS domain for the voice service from the IMS domain is similar to the process shown in FIG. 6 and will not be described herein.

The routing control method of the first embodiment is suitable to a case in which operators are closely associated, the synchronization of routing policy decision information is achieved by a routing control process in which different operators set up and maintain a same gsmSCF functioning as the RPDP. The method of the first embodiment is also suitable to a case in which an operator runs the CS domain and the IMS domain at the same time. According to the method, the operator just needs to upgrade the gsmSCF of the CS domain to an RPDP that has the functions of the gsmSCF and to add an IM-SSF node in the IMS domain before having the CS domain and the IMS domain use a same RPDP. However, when the CS domain and the IMS domain belong to different operators who are not close to each other, the method of the first embodiment is inadequate since the method needs the operators to set up and maintain a network entity together.

The present invention also provides another routing control method for a case in which the CS domain and the IMS domain belong to different operators who are closely associated. According to this method, the operators set up and maintain a shared database (DB) for storing the routing policy decision related information of the subscriber in the CS and the IMS domains so that the routing policies in the two domains will be synchronized. At the same time, a gsmSCF which functions as the RPDP shall be set up in the CS domain and a gsmSCF or an AS which functions as the RPDP shall also be set up in the IMS domain, the RPDPs of the two domains access the shared database to acquire the routing policies of the subscriber of the session or the call in the CS and the IMS domains in order the to control the routing of the call or the session.

A network system employed in the method of the first embodiment includes: a first routing policy storage sub-module, a second routing policy storage sub-module, a first routing information acquiring sub-module, a second routing information acquiring sub-module, a first routing policy decision sub-module, a second routing policy decision sub-module, a first number conversion sub-module, a second number conversion sub-module, a first routing related information acquiring sub-module, a second routing related information acquiring sub-module, a first routed path information acquiring sub-module and a second routed path information acquiring sub-module.

The first and second routing policy storage sub-modules together are called a domain selection policy storage module; the first and second routing information acquiring sub-modules together are called a domain selection information acquiring module; the first and second routing policy decision sub-modules together are called a domain selection module; the first and second number conversion sub-modules together are called a number conversion module; the first and second routing related information acquiring sub-modules together are called a routing related information acquiring module; and the first and second routed path information acquiring sub-modules together are called a routed path information acquiring module.

The first embodiment only includes two network domains, yet in practical applications, the method may also be applied to more than two network domains, and the network system accordingly may include more than two routing policy storage sub-modules, routing information acquiring sub-modules, routing policy decision sub-modules, number conversion sub-modules, routing related information acquiring sub-modules or routed path information acquiring sub-modules, and each of the sub-modules with the same name has the same functions but serves different network domains.

All of the sub-modules are installed in the entity where the RPDP of the CS domain is located, the first routing policy storage sub-module, the first routing information acquiring sub-module, the first routing policy decision sub-module, the first number conversion sub-module, the first routing related information acquiring sub-module and the first routed path information acquiring sub-module are set up in the gsmSCF of the CS domain, and the second routing policy storage sub-module, the second routing information acquiring sub-module, the second routing policy decision sub-module, the second number conversion sub-module, the second routing related information acquiring sub-module and the second routed path information acquiring sub-module are set up in the gsmSCF of the IMS domain.

The first routing policy storage sub-module is used for storing the routing policy of the subscriber in the CS domain and the second routing policy storage sub-module is used for storing the routing policy of the subscriber in the IMS domain.

The first routing information acquiring sub-module acquires the routing policies of the subscriber in the two domains respectively from the first and the second routing policy storage sub-modules, and transmits the routing policies to the first routing policy decision sub-module.

The first routed path information acquiring sub-module acquires the routed path information of the voice service in the IMS domain from the second routed path information acquiring sub-module, i.e., acquires information on whether the call has been routed in the IMS domain, and transmits the information to the first routing policy decision sub-module.

The first number conversion sub-module determines the subscriber ID in the IMS domain corresponding to the received subscriber ID in the CS domain according to a predetermined domain name of the IMS domain or a corresponding relation stored in the first number conversion sub-module between the subscriber ID in the CS domain and the subscriber ID in the IMS domain, and sends the acquired subscriber ID in the IMS domain to the first routing related information acquiring sub-module.

The first routing related information acquiring sub-module acquires the registration information and the subscription information of the subscriber in the CS and the IMS domains from the HSS and the HLR according to the subscriber ID in the CS and the IMS domains, and transmits the acquired information to the first routing policy decision sub-module.

The first routing policy decision sub-module controls the routing of the call according to the received routing policies of the subscriber in the CS and the IMS domains, the registration information and corresponding service subscription information of the subscriber in the two domains and the routed path information of the subscriber in the IMS domain.

The second routing information acquiring sub-module acquires the routing policies of the subscriber in the two domains respectively from the first and the second routing policy storage sub-modules, and transmits the routing policies to the second routing policy decision sub-module.

The second routed path information acquiring sub-module acquires the routed path information of the voice service in the IMS domain from the first routed path information acquiring sub-module, i.e., acquires the information on whether the call has been routed in the CS domain, and transmits the information to the second routing policy decision sub-module.

The second number conversion sub-module determines the subscriber ID in the CS domain corresponding to the received subscriber ID in the IMS domain according to a predetermined domain name of the IMS domain or a corresponding relation stored in the first number conversion sub-module between the subscriber ID in the CS domain and the subscriber ID in the IMS domain, and sends the acquired subscriber ID in the CS domain to the second routing related information acquiring sub-module.

The second routing related information acquiring sub-module acquires the registration information and the subscription information of the subscriber in the CS and the IMS domains from the HSS and the HLR of the CS and the IMS domains according to the subscriber ID in the CS and the IMS domains, and transmits the acquired information to the second routing policy decision sub-module.

The second routing policy decision sub-module controls the routing of the call in the IMS domain according to the received routing policies of the subscriber in the CS and the IMS domains, the registration information and corresponding service subscription information of the subscriber in the two domains and the routed path information of the subscriber in the CS domain.

In the embodiment of the method in which different operators set up and maintain a shared database, a network system employed includes: a domain selection policy storage module, a first routing information acquiring sub-module, a second routing information acquiring sub-module, a first routing policy decision sub-module, a second routing policy decision sub-module, a first number conversion module, a second number conversion module, a first routing related information acquiring sub-module, a second routing related information acquiring sub-module, a first routed path information acquiring sub-module and a second routed path information acquiring sub-module.

The first routing information acquiring sub-module, the first routing policy decision sub-module, the first number conversion sub-module, the first routing related information acquiring sub-module and the first routed path information acquiring sub-module are set up in the gsmSCF of the CS domain, and the second routing information acquiring sub-module, the second routing policy decision sub-module, the second number conversion sub-module, the second routing related information acquiring sub-module and the second routed path information acquiring sub-module are set up in the gsmSCF or the AS of the IMS domain. The domain selection policy storage module may be set up separately from the RPDPs of the CS and the IMS domains.

The functions of the modules in this network system are basically the same as the functions of the modules in the network system of the first embodiment, and the only difference is that in this network system the in domain routing policy storage module stores the routing policies of the subscriber in the CS and the IMS domains, and both the first and second routing information acquiring sub-modules have to acquire the routing policies of the subscriber in the two domains from the domain selection policy storage module. This network system will not be described further herein.

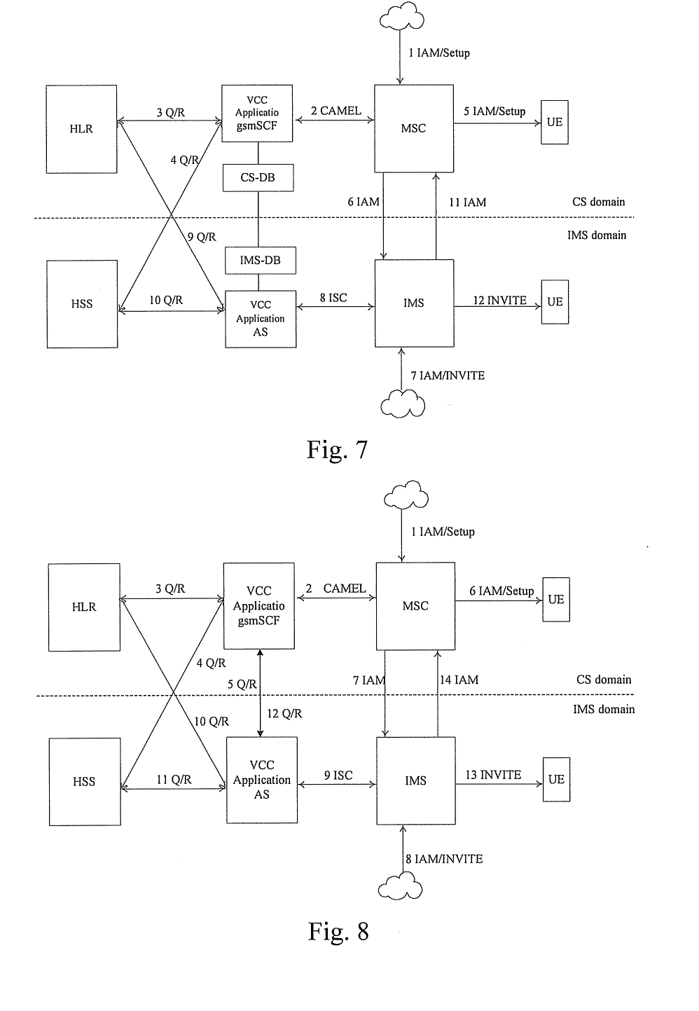

FIG. 7 shows a second embodiment of the present invention illustrating a method for routing control of a voice service based on service trigger. In FIG. 7, two databases are set up, i.e., the CS-DB in the CS domain and the IMS-DB in the IMS domain. The CS-DB and the IMS-DB store the routing policies of the subscriber in the CS and the IMS domains. The two databases may be synchronized according to a predetermined database synchronization policy, which includes but is not limited to: realtime synchronization, periodical synchronization, synchronization upon update, etc.

The gsmSCF which functions as the RPDP of the CS domain accesses the CS-DB via a private interface or an internal interface to acquire the routing policies, number conversion information and routed path information of the subscriber in the CS and the IMS domains, and the AS or the gsmSCF which functions as the RPDP of the IMS domain may also access the IMS-DB via a private interface or an internal interface to acquire the routing policies, number conversion information and routed path information of the subscriber in the CS and the IMS domains.

Upon receipt of a call initiated in the CS domain, the gsmSCF which functions as the RPDP of the CS domain controls the routing of the call in a way similar to the routing control method of the first embodiment, and the only difference is that in this embodiment the gsmSCF accesses the CS-DB of the CS domain to acquire the routing policies of the subscriber in the CS and the IMS domains; and also similarly the AS or the gsmSCF which functions as the RPDP of the IMS domain accesses the IMS-DB to acquire the routing policies of the subscriber in the CS and the IMS domains, and the detailed process will not be described herein.

The consistency of the routing control in the second embodiment is maintained by the gsmSCF or the AS accessing databases which are synchronized according to a predetermined synchronization policy, the RPDPs of the two domains may control the routing of the call or the session according to the same routing policy, which guarantees the consistency of the whole routing control process as well as prevents the roundabout routing or cycling routing incurred by unsynchronized routing policy information in different domains.

A network system employed in the method of the second embodiment includes: a first routing policy storage sub-module, a second routing policy storage sub-module, a first routing information acquiring sub-module, a second routing information acquiring sub-module, a first routing policy decision sub-module, a second routing policy decision sub-module, a first number conversion sub-module, a second number conversion sub-module, a first routing related information acquiring sub-module, a second routing related information acquiring sub-module, a first routed path information acquiring sub-module and a second routed path information acquiring sub-module.

The first routing policy storage sub-module may be set up separately from the gsmSCF of the CS domain while the first routing information acquiring sub-module, the first routing policy decision sub-module, the first number conversion sub-module, the first routing related information acquiring sub-module and the first routed path information acquiring sub-module are set up in the gsmSCF of the CS domain. The second routing policy storage sub-module may be set up separately from the AS of the IMS domain while the second routing information acquiring sub-module, the second routing policy decision sub-module, the second number conversion sub-module, the second routing related information acquiring sub-module and the second routed path information acquiring sub-module are set up in the AS of the IMS domain.

The functions of the sub-modules in the second embodiment are basically the same as the functions of the sub-modules in the first embodiment, and the only difference is that in the second embodiment, the routing policies of the subscriber in the CS and the IMS domains are stored in both the first and second routing policy storage sub-modules which are synchronized according to a predetermined synchronization policy. Therefore the first routing information acquiring sub-module may acquire the routing policies of the subscriber in the CS and the IMS domains from the first routing policy storage sub-module and the second routing information acquiring sub-module may also acquire the routing policies of the subscriber in the CS and the IMS domains from the second routing policy storage sub-module. The functions of other sub-modules will not be described herein.

FIG. 8 shows a third embodiment of the present invention illustrating a method for routing control of a voice service based on service trigger. In FIG. 8, the gsmSCF that functions as the RPDP of the CS domain stores only the routing policy of the subscriber in the CS domain while the AS that functions as the RPDP of the IMS domain stores only the routing policy of the subscriber in the IMS domain, hence an interface is needed between the AS and the gsmSCF so that the AS and the gsmSCF may access each other to acquire the routing policies of the subscriber in the domains of each other.

Upon receipt of a call from the CS domain, the gsmSCF of the CS domain interrogates the HLR or the HSS for the registration information and corresponding service subscription information and acquires the routing policy of the subscriber in the CS domain from the routing policy information stored in the gsmSCF as well as acquires the routing policy of the subscriber in the IMS domain, the subscriber ID in the IMS domain and the routed path information of the call in the IMS domain from the routing policy information stored in the AS via the interface to the AS.

Upon receipt of a session from the IMS domain, the AS of the IMS domain interrogates the HLR or the HSS for the registration information and corresponding service subscription information and acquires the routing policy of the subscriber in the IMS domain from the routing policy information stored in the AS as well as acquires the routing policy of the subscriber in the CS domain, the subscriber ID in the CS domain and the routed path information of the call in the CS domain from the routing policy information stored in the gsmSCF via the interface to the gsmSCF.

In this embodiment, the routing control process is basically the same as the routing control process in the first embodiment after the routing policies of the called subscriber in the CS and the IMS domains, the subscriber ID and the routed path information are acquired, hence the routing control process will not be further described herein.

The gsmSCF and the AS in the third embodiment maintain the routing control consistency by exchanging information with each other. Therefore the RPDPs of the two domains control the routing of the call or the session according to the same routing policy information, which guarantees the consistency of the whole routing control process as well as prevents the roundabout routing or cycling routing incurred by unsynchronized routing policy information in different domains. Furthermore, in this embodiment operators only need to maintain the routing policy information in the domains of their own, no additional routing policy information maintenance is required.

A network system employed in the method of the third embodiment includes: a first routing policy storage sub-module, a second routing policy storage sub-module, a first routing information acquiring sub-module, a second routing information acquiring sub-module, a first routing policy decision sub-module, a second routing policy decision sub-module, a first number conversion sub-module, a second number conversion sub-module, a first routing related information acquiring sub-module, a second routing related information acquiring sub-module, a first routed path information acquiring sub-module and a second routed path information acquiring sub-module.

The first routing policy storage sub-module, the first routing information acquiring sub-module, the first routing policy decision sub-module, the first number conversion sub-module, the first routing related information acquiring sub-module and the first routed path information acquiring sub-module are set up in the gsmSCF of the CS domain, and the second routing policy storage sub-module, the second routing information acquiring sub-module, the second routing policy decision sub-module, the second number conversion sub-module, the second routing related information acquiring sub-module and the second routed path information acquiring sub-module are set up in the AS of the IMS domain.

The functions of the sub-modules are basically the same as the functions of the sub-modules in the first embodiment, and the only different is that in this embodiment, the first routing policy storage sub-module stores the routing policy of the called subscriber in the CS domain and the second routing policy storage sub-module stores the routing policy of the called subscriber in the IMS domain, therefore the first and the second routing information acquiring sub-modules have to acquire the routing policies of the called subscriber in the CS and the IMS domains from both the first and second routing policy storage sub-modules. This network system will not be described further herein.

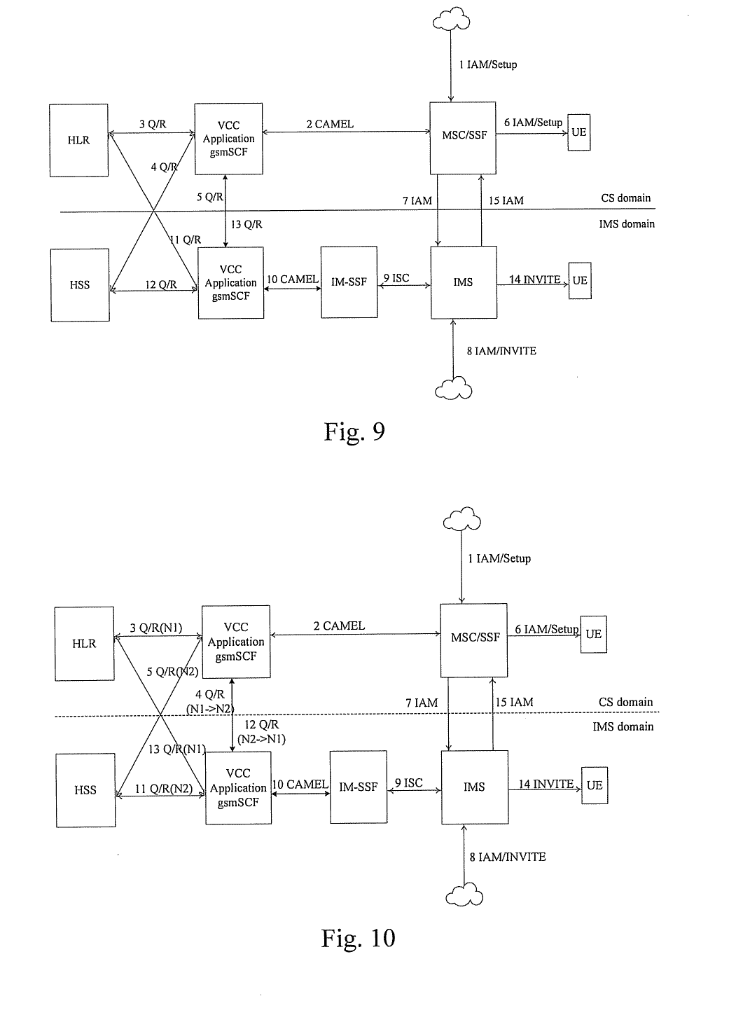

FIG. 9 shows a fourth embodiment of the present invention illustrating a method for routing control of a voice service based on service trigger. In FIG. 9, the gsmSCF which functions as the RPDP of the CS domain stores only the routing policy of the subscriber in the CS domain and the gsmSCF which functions as the RPDP of the IMS domain stores only the routing policy of the subscriber in the IMS domain. Because a private protocol on the data access interface between SCFs has been put forward among some operators, an extension of the private protocol may be used for enabling the gsmSCFs to support the interrogation for routing policies, subscriber IDs and routed path information between each other, a new interface may also be added between the gsmSCFs so that the gsmSCFs may access each other to acquire the routing policies, the subscriber IDs and the routed path information of the called subscriber in the domains of each other.

Upon receipt of a call from the CS domain, the gsmSCF of the CS domain interrogates the HLR or the HSS for the registration information and corresponding service subscription information and acquires the routing policy of the subscriber in the CS domain from the routing policy information stored in the gsmSCF as well as acquires via the new interface the routing policy of the subscriber in the IMS domain from the routing policy information stored in the other gsmSCF and the subscriber ID in the IMS domain and the routed path information of the call in the IMS domain from information stored in the other gsmSCF.

Upon receipt of a session from the IMS domain, the gsmSCF of the IMS domain interrogates the HLR or the HSS for the registration information and corresponding service subscription information and acquires the routing policy of the subscriber in the IMS domain from the routing policy information stored in the gsmSCF of the IMS domain as well as acquires via the new interface the routing policy of the subscriber in the CS domain from the routing policy information stored in the gsmSCF of the CS domain and the subscriber ID in the CS domain and the routed path information of the call in the CS domain from information stored in the gsmSCF of the CS domain.

In this embodiment, the routing control process is basically the same as the routing control process in the first embodiment after the routing policies of the called subscriber in the CS and the IMS domains have been acquired, hence the process will not be described further herein.

The gsmSCFs in the fourth embodiment maintain the routing control consistency by exchanging information with each other. Therefore the RPDPs of the two domains control the routing of the call or the session according to the same routing policy information, which guarantees the consistency of the whole routing control process as well as prevents the roundabout routing or cycling routing incurred by unsynchronized routing policy information in different domains. Furthermore, in this embodiment operators only need to maintain the routing policy information in the domains of their own, no additional routing policy information maintenance is required.

A network system employed in the fourth embodiment is basically the same as the network system employed in the third embodiment. However, the first routing policy storage sub-module, the first routing information acquiring sub-module, the first routing policy decision sub-module, the first number conversion sub-module, the first routing related information acquiring sub-module and the first routed path information acquiring sub-module are set up in the gsmSCF of the CS domain, and the second routing policy storage sub-module, the second routing information acquiring sub-module, the second routing policy decision sub-module, the second number conversion sub-module, the second routing related information acquiring sub-module and the second routed path information acquiring sub-module are set up in the gsmSCF of the IMS domain. This network system will not be described further herein.

The fore-going methods all include the steps of acquiring routing policy decision related information of the subscriber, e.g., the registration information and corresponding service subscription information of the subscriber, by an RPDP from the HLR or the HSS in the home domains of the RPDP and from the domain of the opposite end. When the RPDP acquires the routing policy decision related information from the HLR or the HSS in the home domain of the RPDP, the RPDP still uses the subscriber ID of the called subscriber in the home domain; when the RPDP acquires the routing policy decision related information from the HLR or the HSS in the domain of the opposite end, the RPDP has to use the subscriber ID of the called subscriber in the domain of the opposite end. So the RPDP also has to acquire corresponding subscriber ID of the called subscriber in the domain of the opposite end as well as the routing policy of the called subscriber in the domain of the opposite end before interrogating the HLR or the HSS in the domain of the opposite end for the routing policy decision related information according to the subscriber ID of the called subscriber in the domain of the opposite end.

The subscriber may use an unrelated ID or a related ID for the service subscription in the CS domain and the service subscription in the IMS domain, e.g., the subscriber IDs of the subscriber in the CS domain and the IMS domain of a same operator may be related or unrelated. When the subscriber IDs in the two domains are related, the subscriber ID is in the TEL URI format in the IMS domain and in the E.164 format in the CS domain, and the subscriber ID in the TEL URI format is a subscriber ID generated by adding a domain name of the operator to the subscriber ID in the E.164 format, the related subscriber IDs in the two domains may be converted into each other by adding or removing the domain name of the operator. The unrelated subscriber IDs in the two domains in the present invention may be converted to each other by accessing a preset corresponding relation between the subscriber IDs of the subscriber in the CS domain and the IMS domain.

The subscriber ID conversion process in the method of routing control of a voice service based on service trigger is further described hereafter with reference to FIG. 10 and the fourth embodiment. In FIG. 10, the subscriber is supposed to have two numbers N1 and N2, e.g., the subscriber has two subscriber IDs, in which N1 is for the CS domain and N2 is for the IMS domain.

The routing control process of a call initiated in the CS domain, which is controlled by the gsmSCF that functions as the RPDP of the CS domain, includes the following processes.

Process 1: The MSC having the gsmSSF in the CS domain receives a Setup message initiated by the subscriber terminal or an Initial Address Message (IAM).

Process 2: The MSC having gsmSSF sends SRI to the HLR of the CS domain according to the called number of the call, and the HLR returns the Terminating-CAMEL Subscription Information (T-CSI) of the called subscriber to the MSC having gsmSSF; then the MSC or the gsmSSF sends an IDP to a corresponding SCP according to the T-CSI to trigger an intelligent service, and performs the CAMEL interaction with the gsmSCF that functions as the RPDP of the CS domain.

Process 3: The gsmSCF, optionally, interacts with the HLR according to the service logic defined by the service key of the CSI triggered by the gsmSSF to interrogate for the routing policy decision related information of the called subscriber, e.g., the gsmSCF sends an ATI or an ATSI to the HLR to interrogate for the registration information and corresponding service subscription information of the called subscriber in the CS domain.

In Process 3, the gsmSCF uses the subscriber ID of the called subscriber in the CS domain, i.e., N1, when interacting with the HLR.

Process 4: The gsmSCF that functions as the RPDP of the CS domain interacts with the gsmSCF that functions as the RPDP of the IMS domain to acquire the subscriber ID of the called subscriber in the IMS domain, i.e., N2, as well as the routing policy and routed path information of the called subscriber in the IMS domain.

Process 5: The gsmSCF that functions as the RPDP of the CS domain optionally interacts with the HSS of the IMS domain according to the service logic defined by the service key of the CSI triggered by the gsmSSF to interrogate for the routing policy decision related information of the called subscriber, e.g., the gsmSCF of the CS domain sends an ATI or an ATSI to the HSS of the IMS domain to interrogate for the registration information and corresponding service subscription information of the called subscriber in the IMS domain.

In Process 5, the gsmSCF uses the subscriber ID of the called subscriber in the IMS domain, i.e., N2, when interacting with the HSS.

The gsmSCF of the CS domain makes a current routing policy decision of the call according to the registration information, corresponding service subscription information, routed path information and the routing policies of the called subscriber in the CS and the IMS domains. If the call needs to be routed in the CS domain, Process 6 is performed; if the call needs to be routed to the IMS domain, Process 7 is performed.

Process 6: Route the call to the called UE via the Visited MSC (VMSC) of the called subscriber.

Process 7: Route the call to the MGCF via the BGCF, and then route the call to the called UE via the S-CSCF and P-CSCF of the called subscriber.

The routing control process of a call initiated in the IMS domain, which is controlled by the gsmSCF that functions as the RPDP of the IMS domain, includes the following processes.

Process 8: The S-CSCF of the IMS domain receives an INVITE message.

Process 9: The S-CSCF triggers service for the call according to the filter information in the iFC and forwards the INVITE message to the IM-SSF.

Process 10: The IMS-SSF sends an IDP to the gsmSCF according to the VT-IM-CSI of the called subscriber to trigger an intelligent service and perform CAMEL interaction with the gsmSCF.

Process 11: The gsmSCF, optionally, interacts with the HSS according to the service logic defined by the service key of the VT-IM-CSI triggered by the IM-SSF to interrogate for the routing policy decision related information of the called subscriber in the IMS domain, e.g., the gsmSCF sends an ATI or an ATSI to the HSS to interrogate for the registration information and corresponding service subscription information of the called subscriber in the IMS domain.

In Process 11, the gsmSCF uses the subscriber ID of the called subscriber in the IMS domain, i.e., N2, when interacting with the HSS.

Process 12: The gsmSCF that functions as the RPDP of the IMS domain interacts with the gsmSCF that functions as the RPDP of the CS domain to acquire the subscriber ID of the called subscriber in the CS domain, i.e., N1, as well as the routing policy and routed path information of the called subscriber in the CS domain.

Process 13: The gsmSCF that functions as the RPDP of the IMS domain optionally interacts with the HLR of the CS domain according to the service logic defined by the service key of the CSI triggered by the gsmSSF to interrogate for the routing policy decision related information of the called subscriber in the CS domain, e.g., the gsmSCF sends an ATI or an ATSI to the HLR to interrogate for the registration information and corresponding service subscription information of the called subscriber in the CS domain.

In Process 13, the gsmSCF uses the subscriber ID of the called subscriber in the CS domain, i.e., N1, when interacting with the HLR.

The gsmSCF of the IMS domain determines the current routing policy decision of the call according to the acquired registration information, corresponding service subscription information, routed path information and the routing policies of the called subscriber in the CS and the IMS domains. If the call needs to be routed in the IMS domain, Process 14 is performed; if the call needs to be routed to the CS domain, Process 15 is performed.

Process 14: Route the call to the called UE via the S-CSCF and P-CSCF of the called subscriber.

Process 15: Route the call to the MGCF, and further to the called UE via the VMSC of the called subscriber.

The embodiments of the present invention describe only the applications of called oriented routing control in accordance with the voice service routing control method, however, the calling oriented routing control process is similar to the processes described above, and will not be describer further herein.

The embodiments of the present invention describe only the applications of the routing control method for the voice service between the CS domain and the IMS domain, yet the routing control method for the voice service between the 2G CS domain and the 3G CS domain, or for the voice service between multiple IMS domains based on different access types is basically the same as the method described in the embodiments, and will not be described further herein.

However, the called oriented routing control method described above for routing of a voice service based on service trigger deals only with the called oriented routing control of the RPDP in the initial stage of the voice service, and does not deal with the control of the RPDP over the whole call or session process of the voice service. Therefore, when the voice service is terminated normally or the failure occurs with the voice service in the follow-up call or session process, e.g., the called subscriber is unreachable, or the called subscriber does not answer, the RPDP will not be able to control the follow-up call or session process of the voice service.

So the present invention further provides a method for providing a voice service based on service trigger. The method includes that: an RPDP with a Domain Selection Function (DSF) acquires a delivery attempt state of a call or a session of the voice service that has already been routed to the called side, and continues with the call or the session control of the voice service according to the delivery attempt state of the call or the session.

The voice service is a voice service based on service trigger across different domains, and when the different domains are a CS domain and an IMS domain, the voice service based on service trigger includes: a call initiated in the CS domain, wherein the call needs to be routed to the IMS domain and the called oriented routing control of the call is performed by the CAMEL; or a session initiated in the IMS domain, wherein the session needs to be routed to the CS domain and the called oriented routing control of the session is performed by the AS. When the voice service is routed between a 2G CS domain and a 3G CS domain, the voice service based on service trigger in the present invention includes: a call initiated in the 2G CS domain, wherein the call needs to be routed to the 3G CS domain and the called oriented routing control of the call is performed by the CAMEL; or a call initiated in the 3G CS domain, wherein the call needs to be routed to the 2G CS domain and the called oriented routing control of the call is performed by the CAMEL. When the voice service is routed between two IMS domains based on different access types, e.g., one IMS domain based on WLAN access and the other IMS domain based on GPRS access, the voice service based on service trigger in the present invention includes: a session initiated in an IMS domain based on one access type, wherein the session needs to be routed to an IMS domain based on another access type and the called oriented routing control of the session is performed by the AS.

The technical scheme of the present invention is mainly applied to the call or the session control process of the voice service that has already been routed to the called side. For example, when a call initiated in the CS domain is routed by the RPDP of the CS domain for the first time to the IMS domain, the technical scheme of the present invention may handle the follow-up call control process in the IMS domain. For another example, when a session initiated in the IMS domain is routed by the RPDP of the IMS domain for the first time to the CS domain, the technical scheme of the present invention may handle the follow-up session control process in the CS domain, and the call between the 2G CS domain and the 3G CS domain, or between IMS domains based on different access types may also be processed in a similar process.

For a call which is initiated in the CS domain and needs to be routed to the IMS domain, the RPDP is the gsmSCF of the CS domain. The gsmSCF in the present invention will acquire the delivery attempt state of the call in the follow-up call process when the call initiated in the CS domain is routed by the gsmSCF to the IMS domain. The gsmSCF may acquire the delivery attempt state of the call in the follow-up call process by configuring an EDP in the gsmSSF, and then the gsmSSF reports the information to the gsmSCF according to the configured EDP.

In the conventional CAMEL, the following EDPs may be dynamically configured in the gsmSSF by the gsmSCF on the terminating side, as shown in Table 1:

TABLE 1

| EDP in | EDP | |
|---|---|---|
| the CAMEL | Type | EDP Description |
| DP13, T (the | EDP-N, | Indicate that a Busy indication is received |
| Terminating | EDP-R | from the destination switch, and a called |
| subscriber) | | subscriber unreachable event or a call |
| Busy | | set-up failure event may be obtained from |
| | | the HLR or from a release reason value in |
| | | the ISDN User Part (ISUP) signalling |
| DP14, | EDP-N, | Indicate that the timer associated with the |
| T No Answer | EDP-R | T_No_Answer DP expires |
| DP14, | EDP-N, | Indicate that the called accepts the call and |
| T Answer | EDP-R | answers |
| DP 17, | EDP-N, | Indicate that a disconnect indication is |
| T Disconnect | EDP-R | received from the called or the calling |
| DP 18, | EDP-N | Indicate that a disconnect indication is |
| T Abort | | received from the calling during the call |
| | | relay process |

In Table 1, a DP configured as EDP-R by the gsmSCF indicates that when the DP is detected, the gsmSCF requires the gsmSSF to suspend the call and report the triggered DP event to the gsmSCF for an instruction, the gsmSSF will process the call in the follow-up call process according to the received instruction; and a DP configured as EDP-N by the gsmSCF indicates that when the DP is detected, the gsmSCF requires the gsmSSF to notify the gsmSCF of the event and process the call in the follow-up call process according to the process logic of the gsmSSF without waiting for any instruction from the gsmSCF.

According to the present invention, when the gsmSCF determines the route to the called subscriber and sends a CONTINUE operation or a CONNECT operation to the gsmSSF, the gsmSCF may also configure an EDP on the gsmSSF. The EDP may be any one or any combination of the DP13, DP14, DP15, DP17 and DP18 shown in Table 1.

The DP type of the DP13, DP14, DP15 or DP17 on the gsmSSF may be EDP-R, and the DP type of the DP18 may be EDP-N, i.e., when the called subscriber is busy, or does not answer the call, or answers the call, or is disconnected, the gsmSSF should suspend the call and report the DP triggered event to the gsmSCF to ask for an instruction from the gsmSCF, and the gsmSSF shall process the call in the follow-up call process according to the received instruction; when the call is not answered and the calling subscriber aborts the call, the gsmSSF should process the call in the follow-up call process according to the process logic of the gsmSSF itself.

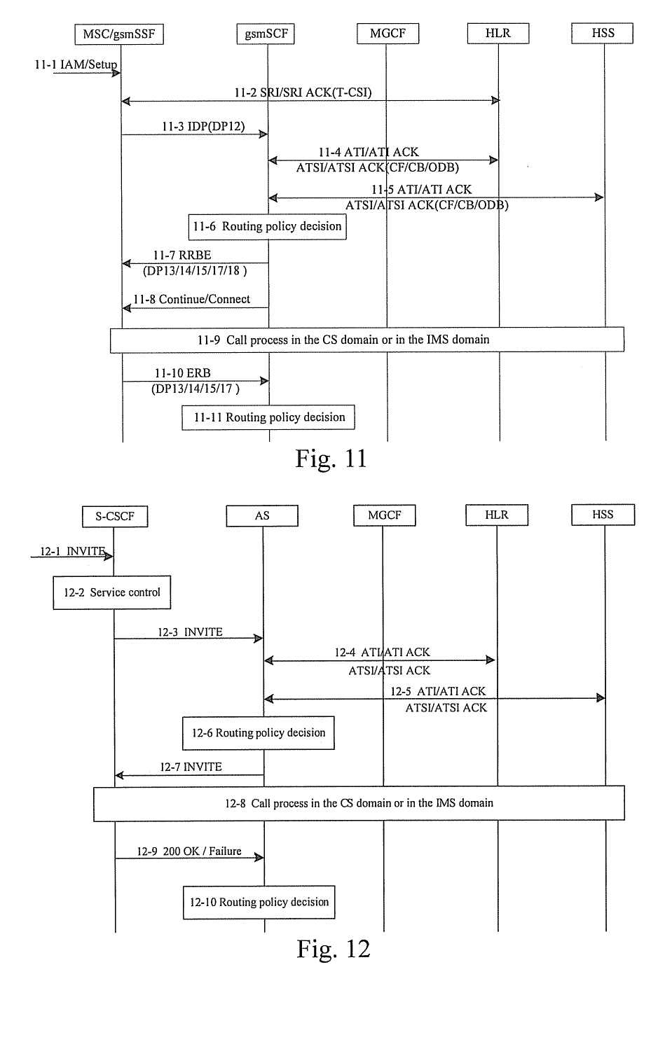

The method for providing a voice service based on CAMEL service trigger is further described hereafter with reference to FIG. 11.

As shown in FIG. 11, the method includes the following steps.

11-1: The MSC which functions as the gsmSSF of the CS domain receives a Setup message initiated by the calling subscriber or an Initial Address Message (IAM).

11-2: The MSC having gsmSSF sends an SRI to the HLR according to the called number and the HLR returns the T-CSI of the called subscriber to the MSC having gsmSSF.

11-3: The MSC having gsmSSF sends an IDP to the corresponding SCP according to the returned T-CSI in order to trigger an intelligent service.

11-4: The gsmSCF, optionally, interacts with the HLR according to the service logic defined by the service key of the CSI triggered by the gsmSSF to interrogate for the routing policy decision related information, e.g., the gsmSCF sends an ATI or an ATSI to the HLR to interrogate for the registration information and corresponding service subscription information of the called subscriber in the CS domain.

11-5: The gsmSCF, optionally, interacts with the HSS according to the service logic defined by the service key of the CSI triggered by the gsmSSF to interrogate for the routing policy decision related information, e.g., the gsmSCF sends an ATI or an ATSI to the HSS to interrogate for the registration information and corresponding service subscription information of the called subscriber in the IMS domain.

In practical applications, 11-4 and 11-5 may also be performed in a reserved order.

11-6: The gsmSCF determines the routing policy for the call according to the acquired routing policy decision related information, e.g., the registration information of the called subscriber in the CS domain and in the IMS domain, corresponding service subscription information and the routing policy information stored in the gsmSCF.

11-7: The gsmSCF sends a Request Report Basic Call State Model (BCSM) Event (RRBE) operation on the gsmSSF according to the determined routing policy, and the RRBE operation includes the DP configured in the gsmSSF, e.g., any one or any combination of the DP13, DP14, DP15, DP17 and DP18.

11-8: The gsmSCF sends a CONTINUE operation to the gsmSSF according to the determined routing policy indicating that the call needs to be routed in the CS domain, or sends a CONNECT operation to the gsmSSF indicating that the call needs to be routed in the IMS domain.

11-9: The gsmSSF routes the call according to the instruction from the gsmSCF and monitors the delivery attempt state during the whole call process according to the EDP configured by the gsmSCF.

11-10: When the gsmSSF detects an event with the EDP configured by the gsmSCF, e.g., when the called subscriber is unreachable, the gsmSSF reports the detected EDP to the gsmSCF.

11-11: The gsmSCF males a decision for the follow-up call control process according to the EDP reported by the gsmSSF and the policy information in the gsmSCF, e.g., when the call succeeds or fails, the gsmSCF may instruct the gsmSSF to disconnect the call, or sends a CONNECT operation to the gsmSSF to require the gsmSSF to re-route the call to the IMS domain.

The gsmSCF is enabled by the technical scheme of the present invention to control and process the call when the call succeeds or fails, and the call success includes that the call is answered by the called subscriber and disconnected normally. The call failure in the CS domain includes that the subscriber has been detached from the network but has not notified the HLR to modify the registration state information of the subscriber, and it is detected that the called subscriber is unreachable when the call is routed to the VMSC or the VLR of the called subscriber or when the call is routed to the VMSC or the VLR of the called subscriber and the VMSC or the VLR pages the called subscriber; or that the VMSC or the VLR detects that the called subscriber does not answer for a long time; or that the VMSC or the VLR detects that the called subscriber is busy. The call failure in the IMS domain includes that the called subscriber has lost the connection to the IMS domain but has not yet notified the HSS to modify the registration state information of the called subscriber, and the S-CSCF detects no response upon timeout or no final response after forwarding the service request to the next hop; or that the session is routed to the P-CSCF of the called subscriber and the P-CSCF detects no response upon timeout or no final response after forwarding the service request to the called subscriber; or that the called subscriber returns a response representing the call failure.

Different networking modes of the gsmSSF may result in different CAMEL service trigger modes. The conventional networking modes of the gsmSSF include: overlay approach and upgrade approach. According to the overlay approach, a limited number of gsmSSFs are added into the network without substantially changing the existing mobile communication network, and intelligent services are carried out in the whole network by triggering the intelligent services with a special number segment. According to the upgrade approach, all the VMSCs should be upgraded into MSCs having the SSF and the intelligent services shall be triggered with the CSI of subscribers. The overlay approach is an interim networking solution while the upgrade approach is the ultimate gsmSSF networking solution.

The workflow in FIG. 11 is based on the CAMEL service trigger mechanism in the upgrade approach, yet the method of the present invention for providing a voice service may also be applied to the CAMEL service trigger in a network employing another approach instead of the upgrade approach, e.g., the overlay approach. The call control process of the voice service triggered by CAMEL service in the overlay approach in accordance with the present invention is the same as the call control process described above, and will not be described further herein.

It can be seen from the fore-going description that method for providing a voice service based on CAMEL service trigger actually provides a call control method for maintaining continuity of the voice service in order to improve the call control mechanism of the voice service. When the call is initiated in the CS domain and the RPDP of the call is the gsmSCF, the gsmSCF configures a series of EDPs in the MSC which functions as the gsmSSF so that the gsmSSF may monitor the delivery attempt state in the follow-up call process according to the configured EDPs and report call events to the gsmSCF when an EDP configured by the gsmSCF is triggered in the call process. Therefore the gsmSCF is able to control the call in the follow-up call process according to the delivery attempt state of the follow-up call process. For example, in the control process of a successful call, through the configured call disconnect EDP in the gsmSSF, the gsmSCF requires the gsmSSF to report the call disconnect EDP upon release of the call so that the gsmSCF may determine to terminate the call according to the DP reported by the gsmSSF and instruct the gsmSSF to release the call or re-route the call to a predetermined address.

In the control process of a failed call, through the configured call failure EDP in the gsmSSF, the gsmSCF requires the gsmSSF to report the call failure EDP and the failure reason when the call fails, hence the gsmSCF may determine the follow-up call process when the called subscriber is unreachable according to the DP and the failure reason reported by the gsmSSF, e.g, the gsmSCF may send to the gsmSSF a disconnect instruction instructing the gsmSSF to release the call, or the gsmSCF may send to the gsmSSF a modifying number instruction instructing the gsmSSF to re-route the call to another domain. In this way the gsmSCF may redirect the call to a new address with the control logic in the follow-up call process when the call is disconnected normally. Therefore the voice service process in normal situations is further enriched and routing control is still provided for the follow-up call process when the failure occurs to the call, which improves the call success ratio.

The call control method for the voice service that has been routed to the called side between the 2G and the 3G CS domains is basically the same as the process illustrated in FIG. 11, and the only difference is that, in the network of 2G and 3G CS domains, when the gsmSCF determines that the call needs to be routed to the other domain, the CONNECT operation sent by the gsmSCF to the gsmSSF carries no number pointing to the MGCF, but a number pointing to an MGW. The detailed process will not be further described herein.

For a call which is initiated in the IMS domain and needs to be routed to the CS domain, the RPDP is the AS of the IMS domain.

According to the definition in the IMS domain of the prior art, the AS may perform service control by terminating a session in a session terminating mode or initiating a session in a session initiating mode, or forwarding a session in a SIP proxy mode, or terminating a session and initiating another session in a B2BUA mode. In the service control process of a session, the AS may remain, according to corresponding service logic, in all follow-up message paths of the session in a standard mode defined by the SIP, or remain only in a SIP transaction message interaction path used for setting up the session.

In the present invention, the AS which functions as the RPDP should perform corresponding service control in the B2BUA mode according to the service logic, i.e., when the AS participates in the IMS session process, the AS first functions as a user agent server to terminate the session forwarded by the S-CSCF, then as a SIP user agent client to initiate a session to the called side determined by the routing policy decision, and performs associating process between the two sessions. For example, upon receipt of the INVITE message initiated by the UE and forwarded by the S-CSCF, the AS may, according to the current routing policy decision, keep the original address information of the called side in the INVITE message to be sent to the S-CSCF, e.g., keep the original Request-URI, or the AS may modify the address information of the called side according to the service logic in the AS, e.g., modify the Request-URI, and the S-CSCF continues with the IMS session, service control process and the next hop routing and forwarding operation according to the address information of the called side in the received INVITE message.

The AS that functions as the RPDP based on the B2BUA mode in the present invention should also remain in all follow-up message paths of the session to learn the delivery attempt state of the whole session process according to the received messages and further to handle the events in the follow-up initiating sections and terminating sections of the session. For example, upon receipt of a session setup failure message, the AS may re-initiate the INVITE message according to the received failure reason and the predetermined routing policy, modify the Request-URI in the message and thus route the session to another domain.

The method for voice service providing based on AS control is further described hereafter with reference to FIG. 12.

As shown in FIG. 12, the method includes the following steps.

12-1: The S-CSCF receives a session signaling, i.e., an INVITE message.

12-2: The S-CSCF triggers service for the session according to the filter information in the iFC and forwards the INVITE message to the AS.

12-3: The AS, optionally, interacts with the HLR according to the defined service logic to interrogate for the routing policy decision related information, e.g., the AS sends an ATI or an ATSI to the HLR to interrogate for the registration information and corresponding service subscription information of the called subscriber in the CS domain.

12-4: The AS, optionally, interacts with the HSS according to the defined service logic to interrogate for the routing policy decision related information, e.g., the AS sends an ATI or an ATSI to the HSS to interrogate for the registration information and corresponding service subscription information of the called subscriber in the IMS domain.

In practical applications, 12-3 and 12-4 may also be performed in a reserved order.

12-5: The AS determines the current routing policy for the session according to the acquired routing decision related information, e.g., the registration information of the called subscriber in the CS domain and in the IMS domain, corresponding service subscription information and the routing policy information stored in the AS.

12-6 and 12-7: The AS sends an INVITE message to the S-CSCF according to the determined routing policy decision. If the session needs to be routed in the IMS domain, the INVITE message will still carry the original address information of the called subscriber, i.e., the original Request-URI, so that the S-CSCF may route the session to the P-CSCF of the called subscriber according to the original Request-URI and the session will be further routed in the IMS domain to the called subscriber. If the session needs to be routed in the CS domain, the INVITE message will carry the modified address information of the called subscriber, e.g., an E.164 number pointing to the MGCF, so that the C-CSCF may route the session to the MGCF through the BGCF according to the E.164 number pointing to the MGCF, and the MGCF further routes the session in the CS domain.

12-8: The S-CSCF routes the session according to the INVITE message from the AS.

12-9: The S-CSCF forwards a session setup success or a session setup failure message to the AS in the follow-up session control process.

12-10: The AS determines the control process for the follow-up session according to the received message and the routing policy stored in the AS, e.g., the AS may instruct the S-CSCF to disconnect the session or re-route the session to the IMS domain no matter the session is successfully set up or the session fails.

The gsmSCF is enabled by the technical scheme of the present invention to control and process the call when the call succeeds or fails, and the call success includes that the call is answered by the called subscriber normally, and disconnected after putting through normally. The call failure in the CS domain includes that the called subscriber has been detached from the network but has not notified the HLR to modify the registration state information of the subscriber, and it is detected that the called subscriber is unreachable when the call is routed to the VMSC or VLR of the called subscriber or when the call is routed to the VMSC or the VLR of the called subscriber and the VMSC or the VLR pages the called subscriber; or that the VMSC or the VLR detects that the called subscriber does not answer for a long time; or that the VMSC or the VLR detects that the called subscriber is busy. The call failure in the IMS domain includes that the called subscriber has lost the connection to the IMS but has not yet notified the HSS to modify the registration state information of the called subscriber, and the S-CSCF detects no response upon timeout or no final response after forwarding the service request to the next hop; or that the session is routed to the P-CSCF of the called subscriber and the P-CSCF detects no response upon timeout or no final response after forwarding the service request to the called subscriber; or that the called subscriber returns a response representing the call failure.

It can be seen from the fore-going description that method for voice service providing based on AS control actually provides a session control method for maintaining continuity of the voice service to improve the session control mechanism of the voice service. When the session is initiated in the IMS domain and the AS functions as the RPDP, the AS controls the service in a B2BUA mode and remains in the follow-up session paths through a standard SIP procedure to acquire the delivery attempt state of the follow-up session process, according to which the AS determines the follow-up session control. For example, if the session is successfully set up, the AS may determine to terminate the session and instruct the S-CSCF to release the session, or determine to redirect the session to a predetermined new address; if the session fails, the AS may determine to terminate the session and instruct the S-CSCF to release the session, or if the AS determines to re-route the session to another domain, a new session setup request to the S-CSCF indicating that the session should be routed to another domain upon receipt of the session failure message. In this way the AS is enabled to redirect the session to a new address with the control logic of the follow-up session process when the session is disconnected normally, which enriches the normal voice service process, and the AS is also able to control the routing of the session when failure occurs to the session and thus improves the session success ratio.

The session control method for the voice service among IMS domains based on different access types is basically the same as the method illustrated in FIG. 12, and the only difference is that, in IMS domains based on different access types, when the AS determines that the session needs to be routed to another domain and sends an INVITE message to the S-CSCF, the INVITE message carries a number pointing to the I-CSCF instead of an E.164 number pointing to the MGCF, and the S-CSCF shall route the session to the I-CSCF according to the number, and then the I-CSCF routes the session to another IMS domain based on another access type. The session control process in IMS domains based on different access types will not be described further herein.

The present invention is described in the foregoing embodiments, however, those skilled in the art may produce a number of modifications and equivalent variations of the present invention without departing from the spirit and scope thereof, therefore any modifications or variations within the technical scope disclosed herein should be covered in the protection scope of the present invention.

What is claimed is:

1. A method for providing a voice service based on service trigger, comprising:
acquiring, by a Routing Policy Decision Point (RPDP) with a Domain Selection Function (DSF), a delivery attempt state of a call or a session, wherein the DSF is capable of selecting a domain; and
controlling, by the RPDP with the DSF, the call or the session in response to the delivery attempt state of the call or the session.

2. The method of claim 1, wherein if the domain selected by the DSF is a Circuit Switched (CS) domain, the RPDP with the DSF is a gsm Service Control Function (gsmSCF) in the CS domain; and if the domain selected by the DSF is an IP Multimedia Sub-system (IMS) domain, the RPDP with the DSF is an Application Server (AS) in the IMS domain.

3. The method of claim 1, wherein if the domain selected by the DSF is a 2G CS domain, the RPDP with the DSF is a gsmSCF in the 2G CS domain; and if the domain selected by the DSF is a 3G CS domain, the RPDP with the DSF is a gsmSCF in the 3G CS domain.

4. The method of claim 1, wherein if the domain selected by the DSF is one of at least two IMS domains based on different access types, the RPDP with the DSF is an AS at a session originating side.

5. The method of claim 1, wherein the RPDP with the DSF is an AS acting as a Back-to-Back User Agent (B2BUA) in an IMS domain to ensure the AS to be remained in the path of the call or the session, and controlling the call or the session in response to the delivery attempt state of the call or the session comprises:
controlling the call or the session in the domain selected by the DSF in response to the delivery attempt state of the call or session.

6. The method of claim 5, wherein controlling the call or the session in the domain selected by the DSF in response to the delivery attempt state of the call or the session comprises:
sending a message for releasing the call or the session; and
re-attempting the call or the session setup to another domain.

7. The method of claim 5, wherein the delivery attempt state of the call or the session acquired by the RPDP with the DSF includes one of:
a successful delivery attempt state of the call or the session; and
a failure delivery attempt state of the call or the session.

8. The method of claims 7, wherein the failure delivery attempt state of the call or the session includes one of:
a called subscriber being busy, and no response from the called subscriber.

9. The method of claim 1, wherein the RPDP with the DSF is one of a gsmSCF in a CS domain, a gsmSCF in a 2G CS domain, and a gsmSCF in a 3G CS domain, and acquiring the delivery attempt state of the call or the session comprises:
configuring an Event Detection Point (EDP) in a gsm Service Switching Function (gsmSSF) in response to the delivery attempt state of the call or the session to be acquired;
monitoring, by the gsmSSF, the delivery attempt state of the call or the session which is routed to a called side with the EDP; and
reporting, by the gsmSSF, the delivery attempt state of the call or the session to the gsmSCF.

10. An apparatus for providing a voice service based on service trigger, the apparatus having Domain Selection Function (DSF) capable of selecting a domain, and comprising:
a first module, configured to acquire a delivery attempt state of a call or a session; and
a second module, configured to control the call or the session in response to the delivery attempt state of the call or the session.

11. The apparatus of claim 10, wherein the apparatus is an AS acting as a Back-to-Back User Agent (B2BUA) in an IMS domain to ensure the AS to be remained in the path of the call or the session, the second module is configured to control the call or the session in the domain selected by the DSF in response to the delivery attempt state of the call or the session.

12. The apparatus of claim 11, wherein the second module comprises:
a first sub-module, configured to send a message for releasing the call or the session; and
a second sub-module, configured to re-attempt the call or the session setup to another domain.

13. A method for routing control of a voice service based on service trigger, comprising:
acquiring, by a Routing Policy Decision Point (RPDP) with a Domain Selection Function (DSF), routing policies of a subscriber of a voice service in different network domains, wherein the DSF is capable of selecting a domain; and
controlling, by the RPDP with the DSF, routing of the voice service in response to the routing policies of the subscriber in different network domains.

14. The method of claim 13, wherein if the domain selected by the DSF is a Circuit Switched (CS) domain, the RPDP with the DSF is a gsm Service Control Function (gsmSCF) in the CS domain, and if the domain selected by the DSF is an IP Multimedia Sub-system (IMS) domain, the RPDP with the DSF is an Application Server (AS) in the IMS domain.

15. The method of claim 13, wherein if the domain selected by the DSF is a 2G CS domain, the RPDP with the DSF is a gsmSCF in the 2G CS domain, and if the domain selected by the DSF is a 3G CS domain, the RPDP with the DSF is a gsmSCF in the 3G CS domain.

16. The method of claim 13, wherein if the domain selected by the DSF is one of at least two IMS domains based on different access types, the RPDP with the DSF is an AS at a session originating side.

17. The method of claim 13, further comprising:
setting up the RPDP with the DSF in an entity where one of RPDPs of different network domains is located, wherein
acquiring, by the RPDP with the DSF, the routing policies of the subscriber of the voice service in different network domains comprises:
acquiring, by the RPDP with the DSF, the routing policies of the subscriber of the voice service in different network domains from the entity.

18. The method of claim 13, further comprising:
setting up the routing policies of the subscriber in different network domains, wherein the routing policies are independent of the RPDP with the DSF and are shared by RPDPs with the DSF of different network domains;
acquiring, by the RPDP with the DSF, the routing policies of the subscriber of the voice service in different network domains comprises:
acquiring, by the RPDP with the DSF, the routing policies of the subscriber of the voice service in different network domains by accessing the routing policies shared by the RPDPs of different network domains.

19. An apparatus for routing control of a voice service based on service trigger, the apparatus having a Domain Selection Function (DSF) capable of selecting a domain, and comprising:
a first module, configured to acquire routing policies of a subscriber of a voice service in different network domains; and
a second module, configured to control the routing of the voice service in response to the routing policies received from the first module.
